(19) United States
(12) Patent Application Publication
(10) Pub. No.: US 2010/0051370 A1
(43) Pub. Date: Mar. 4, 2010

(54) ELECTRIC DEVICE

(76) Inventors: Fu Gen Li, Hunan (CN); Shengliang Zhang, Hunan (CN)

Correspondence Address: MORRISS OBRYANT COMPAGNI, P.C., 734 EAST 200 SOUTH, SALT LAKE CITY, UT, 84102, US

(21) Appl. No.: 12/312,595

(22) PCT Filed: Aug. 20, 2007
(86) PCT No.: PCT/CN2007/002516

§ 371 Date: May 18, 2009

(30) Foreign Application Priority Data
Nov. 24, 2006 (CN) 200620052933.6

(51) Int. Cl. B60L 8/00; B60K 25/00; B60L 11/18; B60K 11/00

(52) U.S. Cl. 180/165; 180/65.31

(57) ABSTRACT

An electric vehicle comprises a body (1-1), an electric driving device (1-2), a storage battery (1-3) and a control system (1-4), wherein the said body is provided with a wind electric power generation device (1-5), several solar panels (1-8) are provided on the top (1-6) of the body and the hood (1-7), the said solar panel (1-8) is electrically connected to the storage battery

### TECHNICAL FIELD

The present invention relates to a vehicle, especially to an electric vehicle.

### BACKGROUND ART

Present domestic and foreign automobiles can be divided into the following three categories: fuel cell electric vehicles, hybrid power vehicles, and full-electric vehicles. The fuel cell electric vehicle is fueled with hydrogen and driven by the power source produced by the chemical reaction between hydrogen and oxygen. Its virtue is its high energy conversion efficiency, which is several times more than that of an internal combustion engine. In addition, the fuel cell electric vehicle, with its compact structure and fewer components possesses the advantages of rich resources and environmental protection due to its pollution-free reaction products like water. However, immature hydrogen fuel energy conversion technology, immature oxygen supply and hydrogen storage technology in high pressure, high cost, and the unviability of commercial production constitute the shortcomings of fuel cell electric vehicles. The hybrid power vehicle, whose power comprises an internal combustion engine and a motor, is driven by using either of them alone or both of them combined. The fuel quantity needed for the hybrid electric vehicle is smaller than that for the full-electric vehicle. Moreover, noise and emissions of hazardous substances caused by the hybrid electric vehicle are reduced. However, the disadvantages are a complicated dynamic system, high cost, too much space needed, and environmental pollution, despite the reduced noise and emission of hazardous substances, which result in a secondary combustion conversion defect. The full-electric vehicle, equipped with a motor controlling apparatus or battery management system, is driven by motor operation powered by a storage battery. The full-electric vehicle has the advantages of structural simplicity, free of fuel, no pollution, low noise, low cost, convenient use and maintenance, and huge economic and social benefits. However, its short continuous driving mileage, low maximum driving velocity, long charging time, great transmission loss, and high cost are the principal drawbacks of the full-electric vehicle. The reasons for said short continuous driving mileage of electric vehicles and the short life of the storage battery are the abundant weight of the whole vehicle, great transmission loss, the single energy supplementation method, small charging speed, and especially the conventional actuation method, causing low energy conversion efficiency. In addition, large connection resistance, the inconvenience of replacing batteries, and great driving energy consumption of the air conditioning system and wiper due to unreasonable battery connection structure cause other reasons for the undesirable performance of electric vehicles. So far, the research effect is not satisfying in spite of the development resulting from continued efforts in the field.

### BRIEF SUMMARY OF THE INVENTION

The object of the present invention is to provide an electric vehicle which can supplement energy with high energy conversion efficiency, low transmission loss, quick velocity response, and long continuous driving mileage.

To achieve the above mentioned objects, an electric vehicle is provided, including a body, an electric driving device, a storage battery, and a control system, characterized in that the said body is provided with a wind electric power generation device, several solar panels are provided on the top of the body and the hood, and the said solar panel is electrically connected to the storage battery.

Moreover, said wind electric power generation device mainly comprises a wind scoop, an impeller chamber, an impeller chamber cover, a blade, a rotor, a driving shaft, a shaft sleeve, a release bearing, a shifting fork, a gear box, an electric power generator, and a control device. Wherein the said wind scoop which can open and close the air inlet is installed on the top of the body. At the end of the wind scoop there is a wind fairing on which an impeller chamber and an air outlet extending into the inside of the vehicle are configured. The said gear box extending to a splined hub and the electric power generator are combined with the body. There is a release bearing configured on the end of the spline shaft sleeve and a shifting fork connecting with a parking handle installed inside the splined hub. One end of the driving shaft is configured with splines nested inside the splined hub, the other end of the driving shaft inserts into the shaft sleeve settled at the bottom of the impeller chamber cover, and the central part of the driving shaft is provided with at least one locating pin. The lower end of a through hole located in the center of the blade is configured on the shaft sleeve and is provided with at least one groove, the upper end of a through hole located in the center of the rotor is configured on the driving shaft below the locating pin and is provided with at least one groove.

Moreover, the said electric driving device comprises a second gear transmission, a driving bridge, and a high-low torque converter. The output end of said second gear transmission is engaged with the driving bridge by a small drive gear, while its input end is connected with the output end of the high-low torque converter whose input end links with a small electric machine clutch and a big electric machine clutch connected with the electric power respectively. A half-shaft used to rotationally drive the wheel is installed in the said driving bridge.

Moreover, an energy accumulator is driven by the engagement between a ratchet thereon and the gear installed on a small driving gear shaft on the output end of the second gear transmission.

Moreover, a solar water heater for heating and cooling is provided at the rear part of the body, the outlets of which are connected with a cycling pump and an absorption-type refrigerating machine respectively. The outputs of the cycling pump and the absorption-type refrigerating machine are connected with the heat changers respectively, the output of which is connected with a ventilator which supplies the heating and cooling adjustment.

Moreover, compressed airbags are provided inside the body interlayer and are inter-connected by pipelines. The outputs of the airbags are connected respectively with a pneumatic wiper and a pneumatic motor linking with an air conditioning compressor.

Moreover, a fly wheel is driven by the engagement between the gear on its shaft and the gear installed on the small driving gear shaft on the output end of the second gear transmission. There is provided a brake clip connected with a hand brake level on said fly wheel. Furthermore, a power generator is installed on the fly wheel.

Moreover, there is also provided an air compressor engaged with the gear of the inner half-shaft of the driving bridge on the said driving device.

Moreover, there is also provided a power generator on the half-shaft of the said driving device, the rotor of which is installed on the half-shaft while the stator is installed on the half shaft-sleeve.

Moreover, said energy accumulator comprises a shell, a positioning shaft, energy storage units, an output gear shaft, and a one-way gear. The said positioning shaft and output gear shaft are installed on the shell in parallel, and the said energy storage units are provided in sequence by splines between the positioning shaft and the output gear shaft on the shell. At an end of the output gear shaft there is an output gear engaged with the one-way gear positioned on the shell, and a positioning pin positioned on the shell is inserted into the said output gear. The said energy storage units include a baffle, ratchet shaft, pawl, gears, and energy storage springs. Said gear, energy storage springs, and baffle are installed in turn on the said ratchet shaft. One side of the baffle is fixed onto the positioning shaft. One end of the energy storage spring is fixed on the ratchet shaft while the other end is connected with the positioning shaft. The outer gear rings of the gear are engaged with the output gear shaft. One end of the pawl is installed on the gear by the positioning pin while the other end is engaged with the ratchet of the outer circle of the ratchet shaft.

Moreover, said energy accumulator can be the combination of several accumulators.

Moreover, rollers are provided on the bottom of the storage battery shell, a flexible positioning ratchet is positioned symmetrically on the lower part outside the storage battery shell, while the output positive and negative pole rods are set on the upper part outside the storage battery shell.

Moreover, the shape of the said pole rod is conical with a through groove in its center.

Moreover, a conical sleeve is clamped in the pole rod hole of the storage battery by a circular flange on the inner surface of the conical sleeve clamped in the round groove set on the pole rod of the storage battery. The outer surface of the conical sleeve is provided with screw threads which are screw jointed with nuts provided on the end of an external connection conducting wire.

Moreover, male and female joints matched with pole rods of the storage battery are provided at the end of the said conducting wire.

The detailed principles and advantages of the invention arc introduced as follows:

1. For the wind electric power generation device in the invention, when parking, the blade can be extended out of the vehicle and rotated by the wind, then the rotating blade will drive the energy power generating device rotating to generate energy power which can be transmitted to the storage battery by the controlling device. When driving or descending hills, the blade can remain in the blade chamber while the wind rotor rotates by the wind ejected out of the wind scoop, which also drives the power generating device, rotating to generate power. When driving, the wind electric power generation device will stop working due to the closed damper of the wind scoop.

2. The solar panels on the top of the body electrically connected to the storage battery in the present invention are useful for the conversion of solar energy to electric energy.

3. The solar water heater for heating and cooling in the present invention transports hot water generated by the solar water heater to the cycling pump or the absorption-type refrigerating machine as a cool-air source and hot-gas source, in order to adjust the air temperature in vehicles.

4. The air conditioning compressor and pneumatic wiper driven by the compressed air installed in the body interlayer contribute to the reduction of power consumption and prolonged life of the storage battery.

5. The structure of the storage battery shell and the connection of the pole rods in the present invention is described as follows: rollers are provided in the corners of the bottom of the storage battery shell, flexible positioning ratchets are positioned on both the lower part of the sides or the ends of the storage battery shell, while the output positive and negative pole rods are set on the upper part outside the storage battery shell. Furthermore, a conical sleeve is clamped in the pole rod hole of the storage battery by a circular flange on the inner surface of the conical sleeve clamped in the round groove of the pole rod of the storage battery. The outer surface of the said conical sleeve is provided with screw threads which are screw jointed with nuts provided on the end of the external connection conducting wire. Moreover, male and female joints matched with the pole rods of the storage battery are provided at the end of the said conducting wire. The pole rods in the present structure are not easily broken or oxidized when pulled by an external force. It is convenient to assemble, disassemble, or move the structure without destroying the storage battery, which is fit for electric vehicles. The rollers installed on the bottom of the storage battery shell are located in the groove on the corresponding location where the storage batteries are located. Thus, the installation is firm and the storage battery can be dragged easily. The flexible positioning ratchets positioned on both sides of the storage battery shell are located in the storage battery frame firmly in the absence of spanners or other fasteners.

6. The said energy accumulator in the present invention can transmit energy to the energy storage units by external force. The energy stored in the energy accumulator can be transmitted into the driving device of the vehicle directly to assist in moving the vehicle when starting or ascending hills. The present invention is suitable for installing on all kinds of vehicles with different sizes or other machines. The energy accumulator with simple construction, light weight, high energy storage, and great torsion moment can transmit energy quickly without pollution. Furthermore, it is convenient to assemble, disassemble, and maintain the structure with low cost and long life. In the future, when co-used with a storage battery, it can increase the torque of the electric vehicle, improve the performance of accelerating, ascending hills, and driving at maximum speed, prolong the continued driving mileage, and reduce the battery number.

7. The electric driving device in the present invention comprises a second gear transmission and a high-low torque converter whose inputs are connected with a small drive electric machine and a big drive electric machine respectively. The vehicles are driven by the big drive electric machine when starting, and are driven by the small drive electric machine when accelerating in order to satisfy the different working conditions in starting and accelerating. Thus, the vehicles are able to work with optimum efficiency and improved energy conversion efficiency. Furthermore, the continued driving mileage and the working condition of the storage battery can be improved, and the life of the driving electric machine and storage battery can be prolonged.

Here is a brief introduction to the advantages of the invention:

1. Due to the wind electric power generation device provided on the body, the solar panels connected with the storage battery on the top of the body and the hood, the generator on the fly wheel engaged with the output shaft of the gearbox, and the generator on the half-shaft of the driving device, the electric vehicles in the present invention can obtain supplemental energy for the storage battery from solar energy or wind power when driving or parking, and can supplement the storage battery with the electric power generated by the fly wheel generator and half-shaft generator when decelerating, so as to increase the continuous driving mileage and life of the storage battery of the electric vehicle.

2. Due to the solar water heater for heating and cooling located on the body, and the compressed airbags installed in the vehicles, the outputs drive the pneumatic motor of the air conditioning compressor and the pneumatic wiper respectively, in order to save electricity consumption of the vehicle and improve the continuous driving mileage and life of the storage battery.

3. Due to the energy accumulator engaged with the small drive gear on the output end of the transmission located on the driving device in the invention, external mechanical energy for the driving device is provided when starting to impel the transmission to drive the wheel. Thus, the loading amount of the driving motor can be decreased, and the working condition and the usage life of the driving motor and storage battery can be improved.

4. Due to the electric driving device comprising the second gear transmission and the high-low torque converter whose inputs are connected with a small drive electric machine and a big drive electric machine respectively, the matching problem of the working condition and the motor power is solved, and furthermore, higher energy conversion can be obtained. That is, the vehicles are driven by the big drive electric machine when starting and are driven by the small drive electric machine when accelerating, in order to satisfy the different working conditions in starting and accelerating. The working conditions of the motor and the storage battery are improved, and the life of the driving electric machine and storage battery can be prolonged. The torque force and drive performance when accelerating, ascending hills, and high-speed driving is improved especially in assistance of the energy accumulator. Thus, the vehicles are able to work with optimum efficiency. The transmission loss can be reduced, while the continuous driving mileage and the loading of the electric vehicles can be improved.

5. Due to the pole rods of the storage battery connected and screw jointed by screw threads with the male and female joints matched with the end of the said conducting wire in the present invention, connection resistance of the storage battery can be decreased so the energy consumption can be reduced. Furthermore, it is convenient to assemble and disassemble the structure.

6. Due to the device for driving the air conditioning compressor and the wiper using compressed gas stored in the interlayer, electric energy can be saved so as to increase the continuous driving mileage.

7. Due to the energy accumulator comprised of several energy storage units with novel structure and light weight, the energy storage, the torque, and the usage life can be increased, and the electric energy consumption can be reduced to increase the continuous driving mileage.

In conclusion, the present invention provides an electric vehicle which can improve the working condition of the vehicles and reduce energy consumption. When driving, the vehicles can obtain energy in several ways to increase the continuous driving mileage of the vehicles and prolong the life of the storage battery and driving motor. The higher energy conversion efficiency makes the vehicle fit for mass production to be the upgraded product of current electric vehicles.

### BRIEF DESCRIPTION OF THE DRAWINGS

FIG. 1 is a front view of the electric vehicle in the invention;

FIG. 2 is a top view of the electric vehicle in the invention;

FIG. 3 shows the structural scheme of the wind electric power generation device in the invention;

FIG. 4 shows an enlarged drawing of section B of FIG. 1 in the invention;

FIG. 5 is a structural scheme of the driving device in the invention;

FIG. 6 is a sectional view in the A-A direction of FIG. 5 in the invention;

FIG. 7 is a schematic diagram of the solar water heater for heating and cooling in the invention;

FIG. 8 is a schematic diagram of the pneumatic air conditioning and wiper in the invention;

FIG. 9 is a structural scheme of the energy accumulator in the invention;

FIG. 10 is a schematic diagram of the storage battery shell in the invention;

FIG. 11 is an enlarged view of section C of FIG. 10 in the invention.

### DETAILED DESCRIPTION OF THE INVENTION

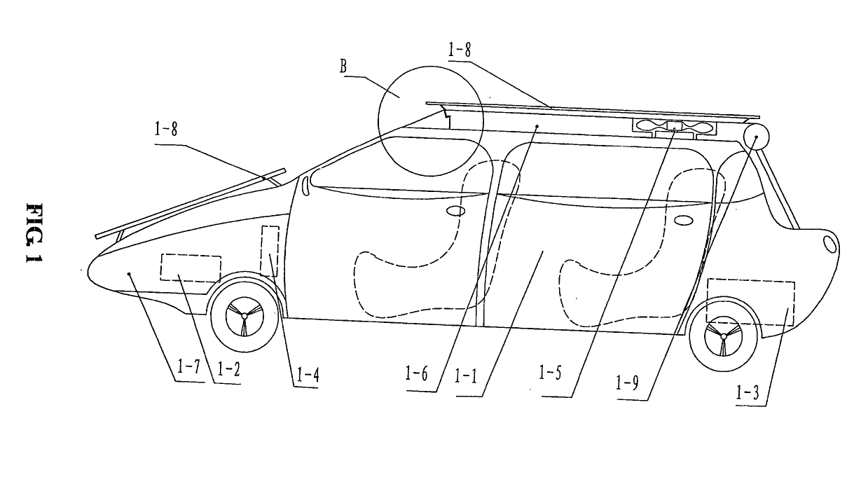

Referring to FIG. 1, an electric vehicle in the present invention comprises a body 1-1, an electric driving device 1-2, a storage battery 1-3, and a control system 1-4, wherein the said body 1-1 is provided with a wind electric power generation device 1-5, and several solar panels 1-8 are provided on the top 1-6 of the body 1-1 and the hood 1-7, and the said solar panel 1-8 is electrically connected to the storage battery 1-3.

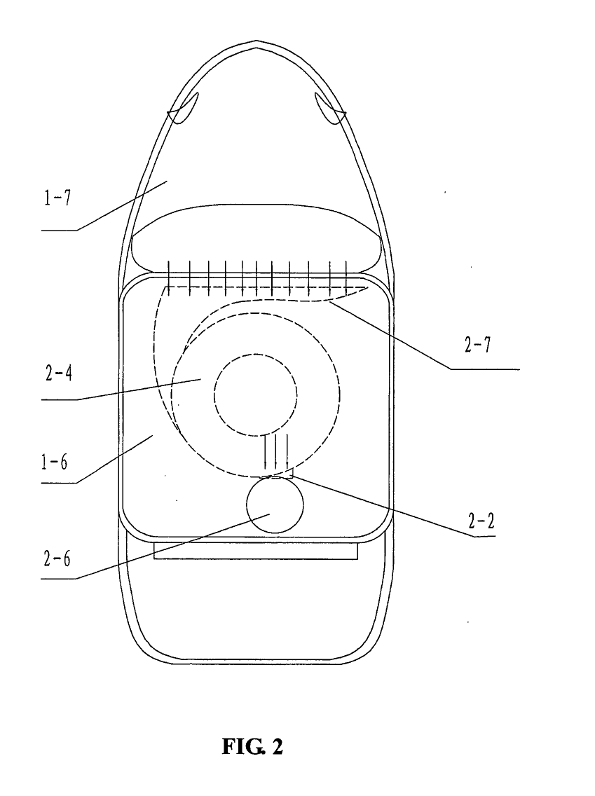

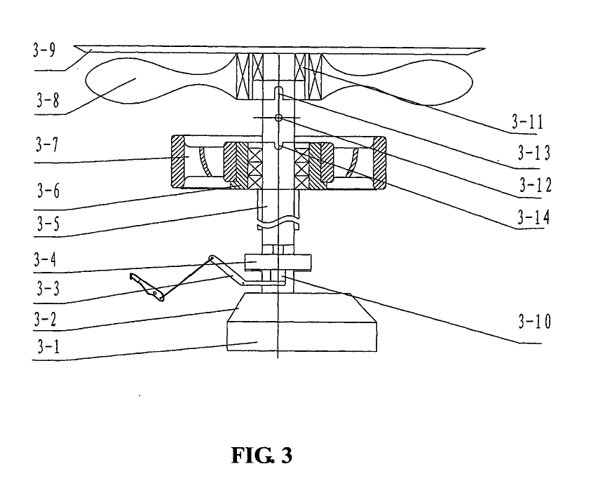

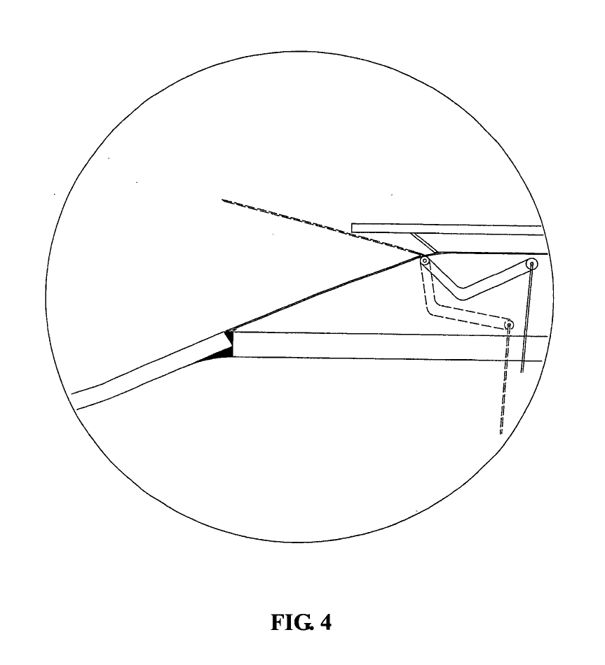

Referring to FIG. 1, FIG. 2, FIG. 3, and FIG. 4, the said wind electric power generation device 1-5 comprises wind scoop 2-4, an impeller chamber 2-6, an impeller chamber cover 3-9, a blade 3-8, a rotor 3-7, a driving shaft 3-5, a shaft sleeve 3-6, a release bearing 3-4, a shifting fork 3-3, a gear box 3-2, and an electric power generator 3-1. Wherein the said wind scoop 2-4 integrated with the body 1-1 which can open and close the air inlet 2-7 is installed on the top 1-6 of the body 1-1. At the end of the wind scoop 2-4 there is a wind fairing 2-2 on which an impeller chamber 2-6 and an air outlet extending into the inside of the vehicle are configured. The said gear box 3-2 extending to a spline shaft sleeve 3-10 and the electric power generator 3-1 are integrated with the body 1-1. There is a release bearing 3-4 configured on the end of the spline shaft sleeve 3-10 and a shifting fork 3-3 connecting with a parking handle installed inside the splined hub 3-10. On one end of the driving shaft 3-5 are splines nested inside the splined hub 3-10, the other end of the driving shaft 3-5 inserts into the shaft sleeve 3-11 settled at the bottom of impeller chamber cover 3-9, and the central part of the driving shaft 3-5 is provided with at least one locating pin 3-12. The lower end of a through hole located in the center of the blade is installed on the shaft sleeve 3-11 and is provided with at least one groove 3-13, the upper end of a through hole located in the center of the rotor 3-7 is installed on the driving shaft 3-5 below the locating pin 3-12 and is provided with at least one groove 3-14.

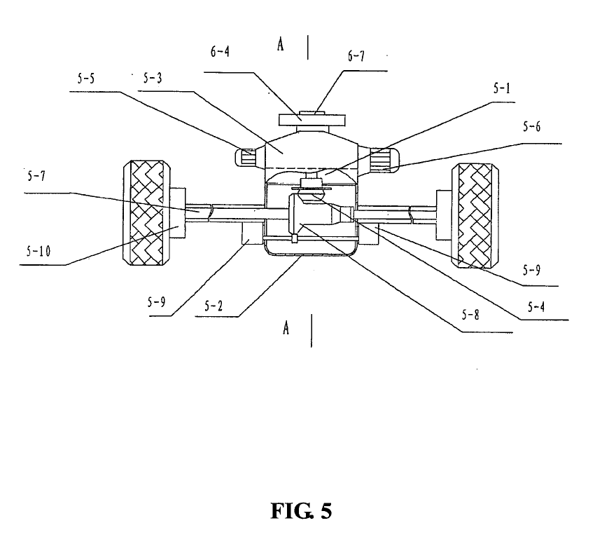

Referring to FIG. 5, the said electric driving device 1-2 comprises a second gear transmission 5-1, a driving bridge 5-2, and a high-low torque converter 5-3. The output end of said second gear transmission 5-1 is engaged with the half-shaft gear 5-8 of the driving bridge 5-2 by a small drive gear 5-4, while its input end is connected with the output of high-low torque converter 5-3 whose input end links with a small electric machine clutch 5-5 and a big electric machine clutch 5-6 connected with the electric power respectively. A half-shaft 5-7 used to drive the wheel to rotate is installed in the said driving bridge 5-2.

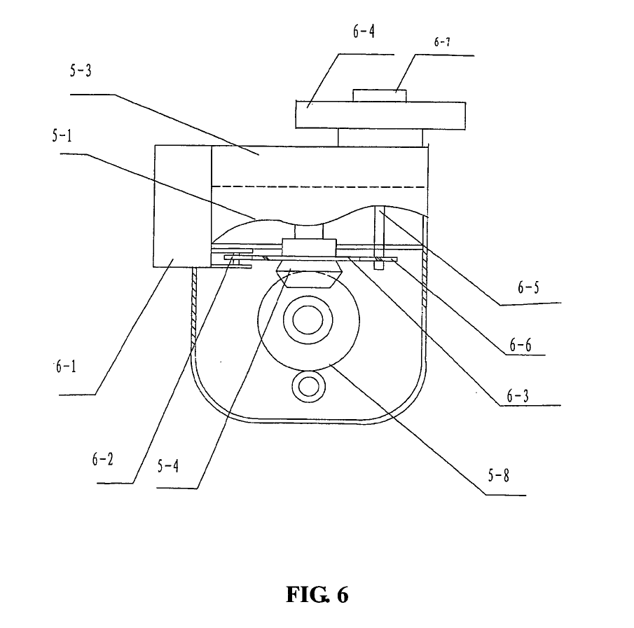

Referring to FIG. 6, an energy accumulator 6-1 is driven by the engagement between a ratchet 6-2 thereon and the gear 6-3 installed on small driving gear shaft 5-4 on the output end of the second gear transmission 5-1.

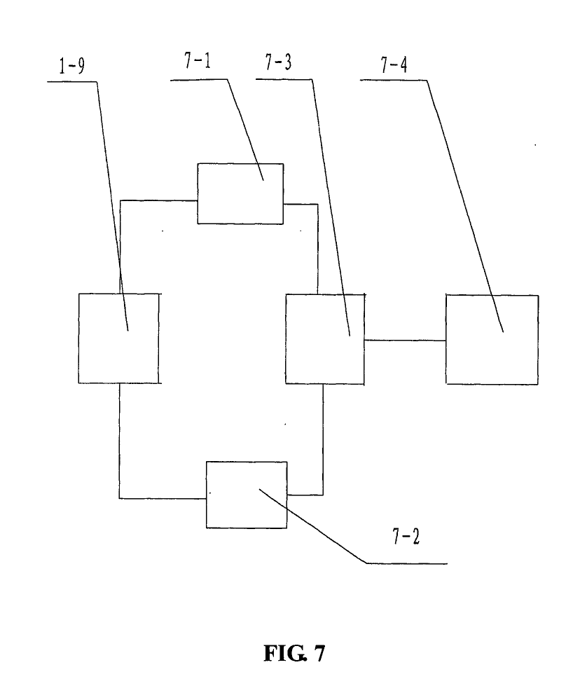

Referring to FIG. 1 and FIG. 7, a solar water heater for heating and cooling 1-9 is provided at the rear part of the body 1-1, the outlet of which is connected with a cycling pump 7-1 and an absorption-type refrigerating machine 7-2 respectively. The outputs of the cycling pump 7-1 and the absorption-type refrigerating machine 7-2 are connected with the heat changer 7-3 respectively, the output of which is connected with a ventilator 7-4 which supplies heating and cooling adjustment for the whole vehicle.

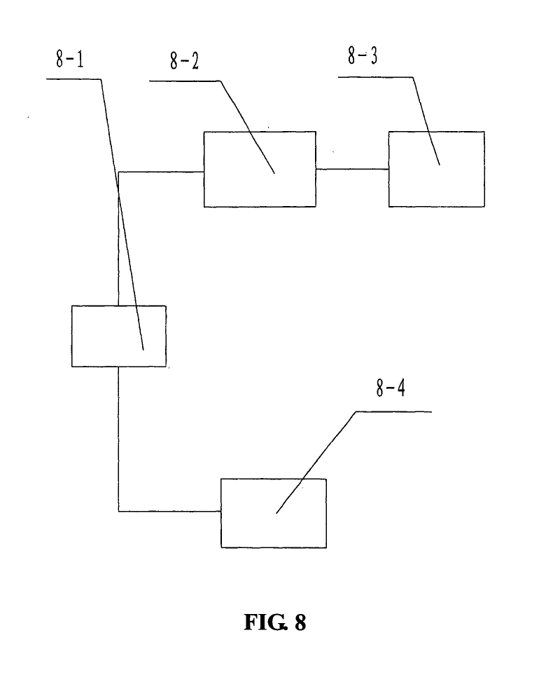

Referring to FIG. 8, compressed airbags 8-1 are provided inside the body 1-1, the said airbags 8-1 installed in the body interlayer are inter-connected by pipelines. The outputs of the airbags 8-1 are connected respectively with pneumatic wiper 8-4 and pneumatic motor 8-2 linking with an air conditioning compressor 8-3.

Referring to FIG. 5 and FIG. 6, a fly wheel 6-4 is driven by the engagement between the gear 6-6 on its shaft 6-5 and the gear 6-3 installed on small driving gear shaft 5-4 on the output end of the second gear transmission 5-1. A brake clip connected with a hand brake level is provided on said fly wheel 6-4. Furthermore, a power generator 6-7 is installed on the fly wheel 6-4.

Referring to FIG. 5 and FIG. 6, there is also provided an air compressor 5-9 engaged with gear 5-8 of the inner-half shaft of the driving bridge 5-2 on the said driving device 1-2.

Referring to FIG. 5, there is also provided a power generator 5-10 on the half-shaft 5-7 of the said driving device 1-2, the rotor of the power generator 5-10 is installed on the half-shaft 5-7 while the stator of which is installed on the half-shaft sleeve.

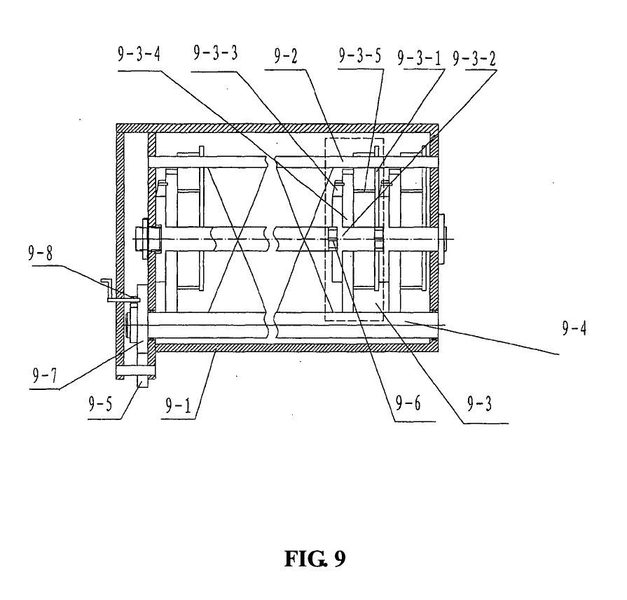

Referring to FIG. 9, the said energy accumulator 6-1 comprises a shell 9-1, a positioning shaft 9-2, energy storage units 9-3, an output gear shaft 9-4 and a one-way gear 9-5. The said positioning shaft 9-2 and output gear shaft 9-4 are installed on the shell 9-1 in parallel, and the said energy storage units 9-3 are connected end to end by splines 9-6 between the positioning shaft 9-2 and output gear shaft 9-4 on the shell 9-1. At an end of the output gear shaft 9-4 there is an output gear 9-7 engaged with the one-way gear 9-5 positioned on the shell 9-1, and a positioning pin 9-8 positioned on the shell 9-1 is inserted in the said output gear 9-7. The said energy storage unit 9-3 includes a baffle 9-3-1, a ratchet shaft 9-3-2, a pawl 9-3-3, a gear 9-3-4, and an energy storage spring 9-3-5, the said gear 9-3-4, energy storage spring 9-3-5, and baffle 9-3-1 are installed in turn on the said ratchet shaft 9-3-2. One side of the baffle 9-3-1 is fixed onto the positioning shaft 9-2. One end of the energy storage spring 9-3-5 is fixed on the ratchet shaft 9-3-2 while the other end is connected with the positioning shaft 9-2. The outer gear ring of the gear 9-3-4 is engaged with the output gear shaft 9-4. One end of the pawl 9-3-3 is installed on the gear 9-3-4 by the positioning pin 9-3-6 while the other end is engaged with the ratchet of the outer circle of the ratchet shaft 9-3-2.

In the present invention, the said energy accumulator 6-1 can be the combination of several accumulators.

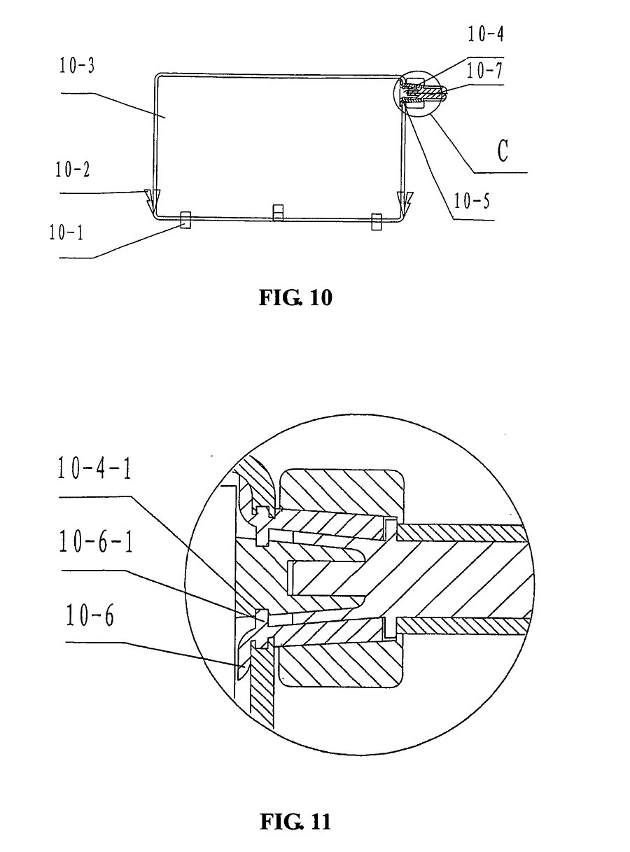

Referring to FIG. 10, rollers 10-1 are provided on the bottom of the storage battery shell 10-3, flexible positioning ratchets 10-2 are positioned on the lower part of the outside of the storage battery shell 10-3 symmetrically, while the output positive and negative pole rods 10-4 are set on the upper part of the outside of the storage battery shell 10-3. The shape of the said pole rods 10-4 is conical with a through groove in its center.

Referring to FIG. 11, a conical sleeve 10-6 is clamped in the pole rod hole 10-5 of the storage battery 10-3 by a circular flange 10-6-1 on the inner surface of the conical sleeve 10-6 clamped in the round groove 10-4-1 of the pole rod 10-4 of the storage battery 1-3. The outer surface of the conical sleeve 10-6 is provided with screws threads which are screw jointed with nuts provided on the end of external connected conducting wire 10-7. Male and female joints matched with pole rod 10-4 of the storage battery 1-3 are provided at the end of the said conducting wire 10-7.

1. An electric vehicle comprises a body, an electric driving device, a storage battery and a control system, characterized in that the said body is provided with a wind electric power generation device, several solar panels are provided on the top of the body and the hood, solar panel is electrically connected to the said storage battery.

2. The electric vehicle of claim 1, characterized in that the wind electric power generation device mainly comprises a wind scoop, an impeller chamber, an impeller chamber cover, a blade, a rotor, a driving shaft, a shaft sleeve, a release bearing, a shifting fork, a gear box, an electric power generator and a control device; wherein the said wind scoop which can open and close the air inlet is installed on and combined with the top of the body, at the end of the wind scoop there is a wind fairing on which an impeller chamber is configured; the said gear box extending to a splined hub and the electric power generator are combined with the body, there is a release bearing configured on the end of the splined hub and a shifting fork connecting with parking handle installed inside the splined hub; One end of the driving shaft are splines nested inside the splined hub, the other end of the driving shaft inserts into the shaft sleeve settled at the bottom of impeller chamber cover, and the central part of the driving shaft are provided with at least one locating pin; The lower end of a through hole located in the central of the blade is installed on the shaft sleeve and is provided with at least one groove, the upper end of a through hole located in the central of the rotor is installed on the driving shaft below the locating pin and is provided with at least one groove.

3. The electric vehicle of claim 1, characterized in that the said electric driving device comprises a second gear transmission, a driving bridge and a high-low torque converter; wherein the output end of said second gear transmission is engaged with the driving bridge by a small drive gear, while its input end is connected with the output of high-low torque converter whose input ends are linking with a small electric machine clutch and a big electric machine clutch connected with the electric power respectively, a half-shaft used to drive the wheel to rotate is installed in the said driving bridge.

4. The electric vehicle of claim 1, characterized in that an energy accumulator is driven by the engagement between a ratchet thereon and the gear installed on small driving gear shaft on the output end of the second gear transmission.

5. The electric vehicle of claim 1, characterized in that a solar water heater for heating and cooling is provided at the rear part of the body, the outlet of which is connected with a cycling pump and an absorption-type refrigerating machine respectively; the outputs of the cycling pump and the absorption-type refrigerating machine are connected with the heat changer respectively, the output of which is connected with a ventilator which supplies the heating and cooling adjustment in the whole vehicle.

6. The electric vehicle of claim 1, characterized in that compressed airbags are provided inside the body, the said airbags installed in the body interlayer are inter-connected by pipelines, and the outputs of the airbags are connected respectively with pneumatic wiper and pneumatic motor linking with an air conditioning compressor.

7. The electric vehicle of claim 1, characterized in that a fly wheel is driven by the engagement between the gear on its shaft and the gear installed on small driving gear shaft on the output end of the second gear transmission, there is provided a brake clip connected with hand brake level on said fly wheel, a power generator is installed on the fly wheel.

8. The electric vehicle of claim 1, characterized in that there is also provided an air compressor engaged with gear of the inner half-shaft of the driving bridge on the said driving device.

9. The electric vehicle of claim 1, characterized in that there is also provided a power generator on the half-shaft of the said driving device, the rotor of said power generator is installed on the half-shaft while the stator of which is installed on the half-shaft sleeve.

10. The electric vehicle of claim 1, characterized in that the said energy accumulator comprises a shell, a positioning shaft, energy storage units, an output gear shaft and a one-way gear, wherein the said positioning shaft and output gear shaft are installed on the shell in parallel, and the said energy storage units are provided in sequence by splines between the positioning shaft and output gear shaft on the shell, at an end of the output gear shaft there is an output gear engaged with the one-way gear positioned on the shell, and a positioning pin positioned on the shell is inserted in the said output gear; the said energy storage unit includes baffle, ratchet shaft, pawl, gears, and energy storage springs, the said gears, energy storage springs and baffle are installed in turn on the said ratchet shaft, one side of the baffle is fixed onto the positioning shaft; one end of the energy storage spring is fixed on the ratchet shaft while the other end of which is connected with the positioning shaft, the outer gear ring of which is engaged with the output gear shaft, one end of the pawl is installed on the gear by the positioning pin while the other end of which is engaged with the ratchet of the outer circle of the ratchet shaft.

11. The electric vehicle of claim 1, characterized in that the said energy accumulator can be the combination of several accumulators.

12. The electric vehicle of claim 1, characterized in that rollers are provided on the bottom of the storage battery shell, flexible positioning ratchet are symmetrically positioned on the lower part outside the storage battery shell, while the output positive and negative pole rods are set on the upper part outside the storage battery shell.

13. The electric vehicle of claim 1, characterized in that the shape of the said pole rods is cone with a through groove in its center.

14. The electric vehicle of claim 1, characterized in that a conical sleeve is clamped in the pole rod hole of the storage battery by a circular flange on the inner surface of the conical sleeve clamped in the round groove of the pole rod of the storage battery, the outer surface of the conical sleeve is provided with screw threads which are screw jointed with nuts provided on the end of an external connected conducting wire.

15. The electric vehicle of claim 1, characterized in that male and female joints matched with pole rod of the storage battery are provided at the end of the said conducting wire.

16. The electric vehicle of claim 3, characterized in that an energy accumulator is driven by the engagement between a ratchet thereon and the gear installed on small driving gear shaft on the output end of the second gear transmission.

17. The electric vehicle of claim 3, characterized in that a fly wheel is driven by the engagement between the gear on its shaft and the gear installed on small driving gear shaft on the output end of the second gear transmission, there is provided a brake clip connected with hand brake level on said fly wheel, a power generator is installed on the fly wheel.

18. The electric vehicle of claim 3, characterized in that the said energy accumulator comprises a shell, a positioning shaft, energy storage units, an output gear shaft and a one-way gear, wherein the said positioning shaft and output gear shaft are installed on the shell in parallel, and the said energy storage units are provided in sequence by splines between the positioning shaft and output gear shaft on the shell, at an end of the output gear shaft there is an output gear engaged with the one-way gear positioned on the shell, and a positioning pin positioned on the shell is inserted in the said output gear; the said energy storage unit includes baffle, ratchet shaft, pawl, gears, and energy storage springs, the said gears, energy storage springs and baffle are installed in turn on the said ratchet shaft, one side of the baffle is fixed onto the positioning shaft; one end of the energy storage spring is fixed on the ratchet shaft while the other end of which is connected with the positioning shaft, the outer gear ring of which is engaged with the output gear shaft, one end of the pawl is installed on the gear by the positioning pin while the other end of which is engaged with the ratchet of the outer circle of the ratchet shaft.

19. The electric vehicle of claim 3, characterized in that the said energy accumulator can be the combination of several accumulators.

20. The electric vehicle of claim 14, characterized in that male and female joints matched with pole rod of the storage battery are provided at the end of the said conducting wire.
